(19) United States
(12) Patent Application Publication
(10) Pub. No.: US 2019/0130529 A1
(43) Pub. Date: May 2, 2019

(54) IMAGE PROCESSING APPARATUS FOR MULTI-PLAYBACK BASED ON TILE IMAGE AND METHOD OF CONSTRUCTING TILE IMAGE USING SAME

(71) Applicant: Konan Technology Inc., Seoul (KR)

(72) Inventors: Hyung-Jae SON, Seoul (KR); Jeong Sun PARK, Hwaseong-si (KR)

(73) Assignee: Konan Technology Inc., Seoul (KR)

(21) Appl. No.: 15/991,449

(22) Filed: May 29, 2018

(30) Foreign Application Priority Data
Nov. 2, 2017 (KR) 10-2017-0145471

(51) Int. Cl. G06T 3/40; G06T 5/50

(52) U.S. Cl. CPC G06T 3/4038; G06T 2200/32; G06T 5/50

(57) ABSTRACT

Disclosed are an image processing apparatus for multi-playback based on a tile image and a method of constructing a tile image using the same. An image processing apparatus according to one embodiment includes a receiver configured to receive a captured image from each of client terminals connected to at least one camera, a processor configured to generate image construction information for constructing a tile image having an image size which is a maximum size acceptable in a display and to construct the tile image by combining the captured images received from the client terminals, a transmitter configured to transmit reference size information of a captured image included in the image construction information to each of the client terminals, and an output unit configured to display the constructed tile image on the display.

### CROSS-REFERENCE TO RELATED APPLICATION

This application claims priority to and the benefit of Korean Patent Application No. 10-2017-0145471, filed on Nov. 2, 2017, the disclosure of which is incorporated herein by reference in its entirety.

### BACKGROUND

### 1. Field of the Invention

The present invention relates to image playback and edit technology. The present invention has been derived from researches carried out as part of Governmental Department Giga KOREA Business of Ministry of Science and ICT and Giga Korea Foundation [Project Number: GK18P0200, Project Name: (4D Realistic Feeling—General/1 Details) Development of Super Realistic Feeling Service Technology based on 4D Restoration and Dynamic Deformation Behavior Model, Research Period: 2017 Apr. 1˜2020 Dec. 31]

### 2. Discussion of Related Art

A plurality of images captured by a camera may be combined into a single tile image and displayed on a display. In this case, the captured images are disposed in an M×N matrix form to form a single tile image. When images are simultaneously captured with multiple high-resolution cameras, a distributed system including one server and several client terminals is generally constructed because it is difficult to process the images in real time by only performance of one PC. For example, cameras disposed at different places, such as CCTVs, may be used for remote monitoring and control. One or more cameras are connected to each client terminal, and all of the captured images are transmitted to the server to be controlled by the server.

### SUMMARY OF THE INVENTION

Embodiments propose an image processing apparatus and a method of constructing a tile image using the same, which are capable of automatically constructing a tile image having an image size, which is acceptable in a display of an image processing apparatus, without a change in an algorithm or software in collecting images captured through a distributed system and simultaneously playing back the images.

An image processing apparatus according to an embodiment includes a receiver configured to receive a captured image from each of client terminals connected to at least one camera, wherein the captured image has a size adjusted to match a reference size of the captured image with respect to an original captured image, a processor configured to generate image construction information for constructing a tile image having an image size which is a maximum size acceptable in a display and to construct the tile image by combining the captured images received from the client terminals, a transmitter configured to transmit reference size information of the captured image included in the image construction information to each of the client terminals, and an output unit configured to display the constructed tile image on the display.

The processor may include a first calculator configured to calculate matrix values including a row number and a column number of the tile image, a second calculator configured to calculate the reference size of each captured image including a reference lateral length and a reference vertical length of the captured image within the tile image, and an image construction unit configured to construct the tile image by combining the captured images, each having a size adjusted to match the reference size of the captured image, based on the image construction information calculated by the first calculator and the second calculator.

The first calculator may calculate the matrix values (R_{N} and C_{N}) using a total number of distributed cameras through each of the client terminals. The first calculator may calculate the row number (R_{N}) by rounding off the square root of the total number of cameras and may calculate the column number (C_{N}) by raising the square root of the total number of cameras.

The second calculator may calculate the reference size of the captured image using the matrix values (R_{N} and C_{N}) calculated by the first calculator, a lateral length (w) and a vertical length (h) of an original image of a camera, and image sizes (X and Y) which are maximum sizes acceptable in the display.

The second calculator may calculate a reference lateral length (W) of the captured image by multiplying a minimum value (min(Xᵣₐₜᵢₒ, Yᵣₐₜᵢₒ, 1)) among the lateral length ratio (Xᵣₐₜᵢₒ) and the vertical length ratio (Yᵣₐₜᵢₒ) of the image, which are maximum sizes acceptable in the display, and 1 and the lateral length (w) of the original image of the camera, and may calculate a reference vertical length (H) of the captured image by multiplying the minimum value (min(Xᵣₐₜᵢₒ, Yᵣₐₜᵢₒ, 1)) among the lateral length ratio (Xᵣₐₜᵢₒ) and the vertical length ratio (Yᵣₐₜᵢₒ) of the image, which are maximum sizes acceptable in the display, and 1 and the vertical length (h) of the original image of the camera. In this case, the lateral length ratio (Xᵣₐₜᵢₒ) of the image, which is a maximum size acceptable in the display, may be a value obtained by dividing the lateral length (X) of the image, which is a maximum size acceptable in the display, by a product (C_{N}×w) of a column number CN of the tile image and the lateral length (w) of the original image of the camera. The vertical length ratio (Yᵣₐₜᵢₒ) of the image, which is a maximum size acceptable in the display, may be the value obtained by dividing the vertical length (Y) of the image, which is a maximum size acceptable in the display, by a product (R_{N}×h) of a row number (R_{N}) of the tile image and the vertical length (h) of the original image of the camera.

The second calculator may confirm whether the size of the tile image corresponds to a first condition in which the size of the tile image does not exceed a maximum size of the image, which is acceptable in the display, a second condition in which the size of each of the captured images forming the tile image should be smaller than or equal to the size of the original image captured by the camera, and a third condition in which an aspect ratio of each of the captured images forming the tile image should be identical to that of the original image captured by the camera, and may calculate the reference lateral length (W) and the reference vertical length (H) of the captured image satisfying all of the first condition to the third condition.

The transmitter may transmit the reference size information of the captured image to each of client terminals along with a capturing command. The receiver may receive each of captured images having a size adjusted to match an image reference size from each client terminal while capturing is performed in each of the client terminals. The processor may generate the tile image by combining the received captured images without a change in size thereof. The output unit may display the generated tile image in real time.

A method of constructing a tile image using an image processing apparatus according to another embodiment includes generating image construction information for constructing a tile image using camera information collected from each of client terminals and display information for displaying the tile image, transmitting reference size information of a captured image within the image construction information to each of the client terminals along with a capturing command, receiving the captured image having a size adjusted to match a reference size of the captured image with respect to the original captured image from each of the client terminals, and constructing the tile image by combining the received images.

The generating of the image construction information may include calculating a matrix value including the row number (R_{N}) and the column number (C_{N}) of the tile image and calculating the reference size of each of the captured images including a reference lateral length (W) and a reference vertical length (H) of the captured image within the tile image. The constructing of the tile image may include constructing the tile image by combining the captured images, each having a size adjusted to match the reference size of the captured image, based on the image construction information calculated by a first calculator and a second calculator.

The calculating of the reference size of the captured image may include calculating the reference lateral length (W) of the captured image by multiplying a minimum value (min(Xᵣₐₜᵢₒ, Yᵣₐₜᵢₒ, 1)) among a lateral length ratio (Xᵣₐₜᵢₒ) and a vertical length ratio (Yᵣₐₜᵢₒ) of an image, which are maximum sizes acceptable in a display, and 1 and a lateral length (w) of the original image of the camera and calculating a reference vertical length (H) of the captured image by multiplying the minimum value (min(Xᵣₐₜᵢₒ, Yᵣₐₜᵢₒ, 1)) among the lateral length ratio (Xᵣₐₜᵢₒ) and the vertical length ratio (Yᵣₐₜᵢₒ) of the image, which are maximum sizes acceptable in the display, and 1 and the vertical length (h) of the original image of the camera. The lateral length ratio (Xᵣₐₜᵢₒ) of the image, which is a maximum size acceptable in the display, may be a value obtained by dividing the lateral length (X) of the image, which is a maximum size acceptable in the display, by a product (C_{N}×w) of the column number (C_{N}) of the tile image and the lateral length (w) of the original image of the camera. The vertical length ratio (Yᵣₐₜᵢₒ) of the image, which is a maximum size acceptable in the display, may be a value obtained by dividing the vertical length (Y) of the image, which is a maximum size acceptable in the display, by a product (R_{N}×h) of the row number (R_{N}) of the tile image and the vertical length (h) of the original image of the camera.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram of a tile image generated by combining images captured through a distributed system in order to help understanding of the present invention;

FIG. 2 shows a configuration diagram of a distributed system for an efficient tile image construction according to one embodiment of the present invention;

FIG. 3 shows a configuration diagram of an image processing apparatus according to one embodiment of the present invention;

FIG. 4 is a flowchart showing a workflow between the image processing apparatus and a client terminal according to one embodiment of the present invention;

FIG. 5 is a reference diagram showing a tile image for illustrating a process of calculating an optimal matrix of a tile image according to one embodiment of the present invention; and

FIG. 6 is a reference diagram showing a tile image for illustrating a process of calculating an optimal size of a captured image according to one embodiment of the present invention.

### DETAILED DESCRIPTION OF EXEMPLARY EMBODIMENTS

The merits and characteristics of the present invention and a method for achieving the merits and characteristics will become more apparent from embodiments described in detail in conjunction with the accompanying drawings. However, the present invention is not limited to the disclosed embodiments, but may be implemented in various different ways. The embodiments are provided to only complete the disclosure of the present invention and to allow those skilled in the art to understand the category of the present invention. The present invention is defined by the category of the claims. The same reference numerals will be used to refer to the same or similar elements throughout the drawings.

In describing embodiments of the present invention, a detailed description of a related known function or configuration related to the present invention will be omitted when it is deemed to make the gist of the present invention unnecessarily vague. Terms to be described hereunder are defined by taking into consideration functions in the embodiments of the present invention, and may be different according to a user, an operator's intention or practice. Accordingly, each term should be defined based on contents over the entire specification.

Combinations of blocks in the accompanying block diagram and operations in a flowchart may be executed by computer program instructions (execution engine). The computer program instructions may be installed in a processor of a general purpose computer, a special purpose computer, or programmable data processing equipment, and thus instructions executed by the processor of the computer or programmable data processing equipment generate parts for executing functions described in the blocks of the block diagram or the operations of the flowchart.

The computer program instructions may be stored in a computer-available or computer-readable memory that may be directed toward a computer or programmable data processing equipment in order to implement a function in a specific manner. Accordingly, the instructions stored in the computer-available or computer-readable memory may also produce an article of manufacture including instruction parts for executing the functions described in the blocks of the block diagram or the operations of the flowchart.

Furthermore, the computer program instructions may be installed in a computer or another programmable data processing equipment to cause a series of operations desired to be performed on the computer or programmable equipment, thus producing a computer-executable process. Accordingly, the instructions executed on the computer or programmable equipment may provide operations for executing the functions described in the blocks of the block diagram or the operations of the flowchart.

Furthermore, each block or each operation may represent part of a module, segment or code including one or more executable instructions for executing specific logical functions. It should be noted that, in some alternative embodiments, the functions described in the blocks or operations may occur in a different order. For example, two blocks or operations shown in succession may, in fact, be executed substantially and concurrently, or the blocks or operations may sometimes be executed in a reverse order, depending upon the functionality involved.

Hereinafter, embodiments of the present invention will be described in detail with reference to the accompanying drawings. However, the embodiments of the present invention may be modified in various other forms, and the scope of the present invention is not limited to the following embodiments. The embodiments of the present invention are provided to a person having ordinary skill in the art to more fully describe the present invention.

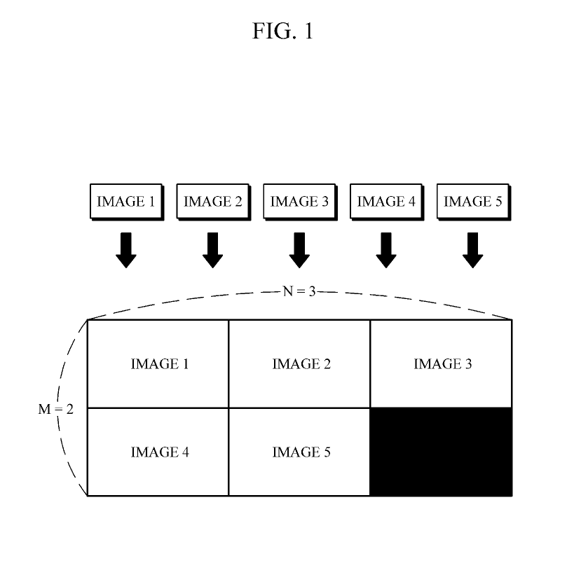

FIG. 1 is an exemplary diagram of a tile image generated by combining images captured through a distributed system in order to help understanding of the present invention.

Referring to FIG. 1, a tile image construction is a method commonly adopted to simultaneously play back a plurality of captured images. The captured images are disposed in an MxN matrix form to form a single tile image. In a case where the number of captured images is smaller than the product of M and N, the remaining space is filled with a single color. For example, as shown in FIG. 1, a tile image of a 2×3 matrix form may be constructed using five captured images and one remaining space.

When images are simultaneously captured with multiple high-resolution cameras, a distributed system including one server and several client terminals is generally constructed because it is difficult to process the images in real time by only performance of one PC. Such a configuration is also used to remotely monitor and control cameras disposed at different places such as CCTVs. One or more cameras are connected to each client terminal, and all of the captured images are transmitted to the server so that the captured images are controlled by the server. In this case, in order to simultaneously check the captured results, an output image is constructed in a tile image form such as that shown in FIG. 1.

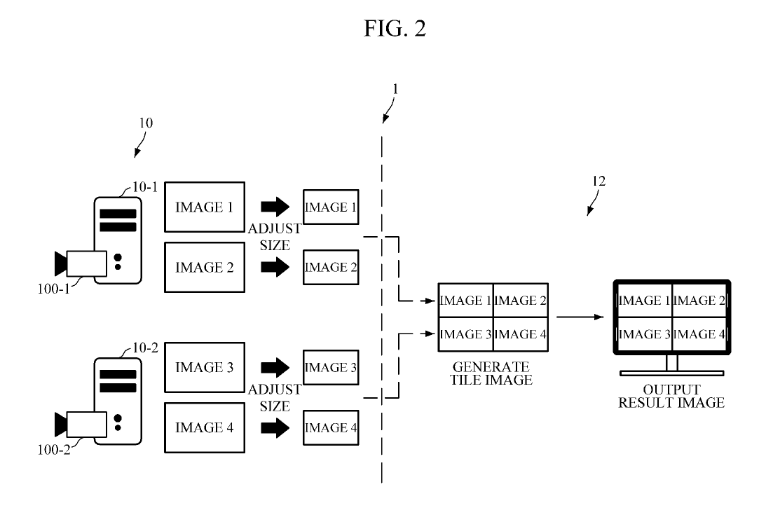

FIG. 2 shows a configuration diagram of a distributed system for an efficient tile image construction according to one embodiment of the present invention.

Referring to FIG. 2, a distributed system 1 includes client terminals 10 which are distributed and an image processing apparatus 12 for multi-playing back distributed images which are captured through the client terminals 10. The image processing apparatus 12 may have a server form. There may be the plurality of client terminals 10. For example, as shown in FIG. 2, two client terminals 10-1 and 10-2 may be configured, but the present invention is not limited thereto. One or more cameras may be connected to each of the client terminals 10. For example, a first camera set 100-1 may be connected to the first client terminal 10-1, a second camera set 100-2 may be connected to the second client terminal 10-2, and each camera set may include two cameras. The cameras may be the same model. The cameras may capture images at the same time. For example, as shown in FIG. 2, the first client terminal 10-1 may obtain an image 1 and an image 2 captured at the same time through each camera of the first camera set 100-1, and the second client terminal 10-2 may obtain an image 3 and an image 4 captured at the same time through each camera of the second camera set 100-2.

The image processing apparatus 12 generates a tile image by combining captured distribution images, and displays the tile image on a display. The display indicates an output device for playing back an image or for executing software implemented to play back an image on an output device. The size of an image, which is a maximum size acceptable in the display, cannot exceed the resolution of the display.

In general, when captured images are received from the client terminals, the image processing apparatus reduces or magnifies the captured images to a suitable size matching the size of an image that may be displayed on the display, and plays back the images. The image processing apparatus may first adjust the size of the captured images and then generate a tile image. In the above example, a task for adjusting the size of the captured images is performed by the image processing apparatus. In this case, resource consumption of the image processing apparatus is inevitable. Accordingly, in a case where the size of the original image is large, real-time playback is difficult because a speed reduction for multi-playback occurs.

For another example, each client terminal may reduce or magnify an output image and transmit the output image to the image processing apparatus. The image processing apparatus may construct a tile image by combining received captured images. In this case, the client terminal simply reduces the size of the image and transmits the image, without taking into consideration of the output size of a display. The image processing apparatus has to re-adjust the image size. Furthermore, in the case where the client terminal reduces the captured image more than necessary when compared to the size of an image capable of being output by the image processing apparatus and transmits the reduced image, unnecessary image quality degradation is generated in the output image.

In order to solve the above-described problem, one embodiment of the present invention proposes a tile image construction method optimized for a display to simultaneously play back images collected through distributed cameras. The proposed method includes a method of calculating the size of a tile image, which is optimized based on an image size which is a maximum size acceptable in the display of the image processing apparatus 12, and row and column values for constructing the tile image and transferring pieces of calculated information to each client terminal 10, so that the client terminal 10 adjusts the size of the captured image to an optimal size and transmits the image to the image processing apparatus 12. As a result, resource consumption of the image processing apparatus 12 can be reduced and faster multi-playback may be possible because a task for adjusting the size of the captured images for constructing the tile image is not processed by the image processing apparatus 12, but the captured images are distributed and processed through the client terminals 10.

Furthermore, in collecting images captured by distributed cameras and simultaneously playing back the images, the tile image can be automatically constructed without a change in an algorithm or software based on the size of an image that may be displayed on the display of the image processing apparatus 12. The optimal size of the captured image is a criterion by which the client terminal 10 changes the image based on the optimal size in response to an instruction from the image processing apparatus 12, and may be used as a “reference size.”

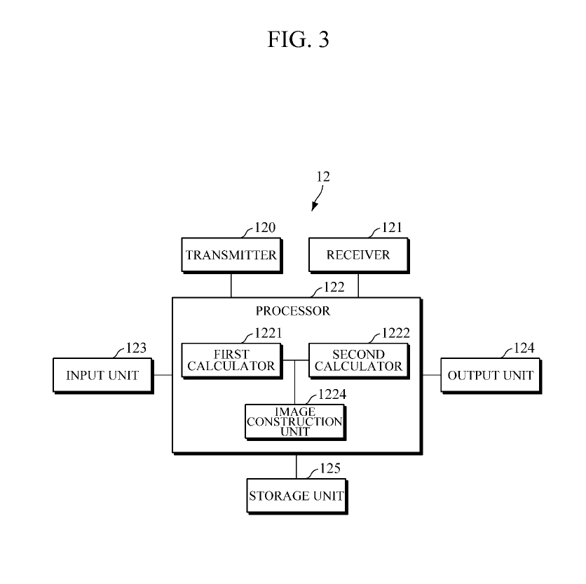

FIG. 3 shows a configuration diagram of an image processing apparatus according to one embodiment of the present invention.

Referring to FIGS. 2 and 3, the image processing apparatus 12 includes a transmitter 120, a receiver 121, a processor 122, an input unit 123, an output unit 124, and a storage unit 125.

The transmitter 120 and the receiver 121 transmit and receive signals to and from each client terminal 10. In this case, the signal includes information necessary for a network through which the image processing apparatus 12 is connected to each client terminal 10, information to be transmitted when the image processing apparatus 12 and each client terminal 10 are connected through the network, information for a tile image construction after the image processing apparatus 12 and each client terminal 10 are connected through the network, and a captured image. The receiver 121 according to one embodiment receives a captured image from each client terminal 10. The size of the received captured image is already adjusted. The adjustment of the image size is performed based on optimal size information of the captured image transmitted from the image processing apparatus 12 to the client terminal 10 through the transmitter 120. For example, the size of the captured image is reduced based on the optimal size of the captured image.

The image processing apparatus 12 receives information necessary for the tile image construction through the receiver 121 by requesting the information from the client terminal 10 through the transmitter 120. For example, the image processing apparatus 12 receives camera information through the receiver 121 by requesting the camera information from the client terminal 10 through the transmitter 120. The camera information includes the number of cameras connected to each client terminal 10 and a lateral length and a vertical length of camera resolution. When optimal size information of each captured image within the tile image is calculated by the processor 122, the transmitter 120 transmits the calculated optimal size information of the captured image to the client terminal 10. The client terminal 10 adjusts the size of the captured image to match the received optimal size information of the captured image. The receiver 121 receives the captured image having the adjusted size from the client terminal 10.

The processor 122 controls an overall operation of the image processing apparatus 12. The processor 122 according to one embodiment generates image construction information capable of constructing a tile image having a maximum image size acceptable in a display, and constructs the tile image by combining captured images received from client terminals.

The processor 122 according to one embodiment includes a first calculator 1221, a second calculator 1222, and an image construction unit 1224.

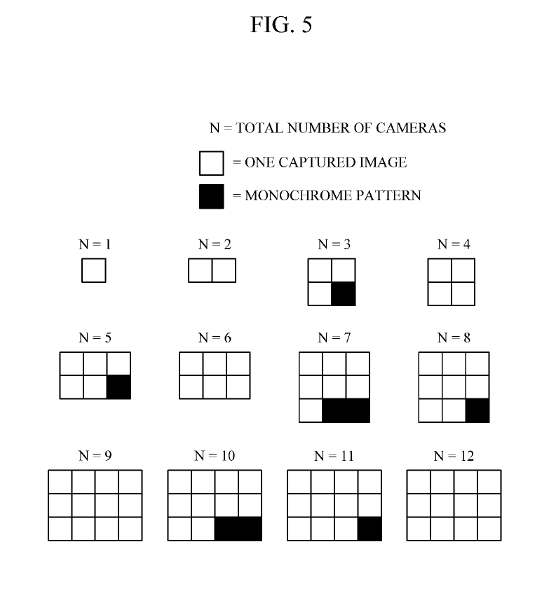

The first calculator 1221 calculates an optimal matrix value of a tile image generated by combining captured images. The optimal matrix value includes an optimal row number R_{N} and an optimal column number C_{N} of the tile image. The first calculator 1221 according to one embodiment calculates an optimal matrix value using a total number of distributed cameras N. For example, the first calculator 1221 calculates the optimal row number R_{N} by rounding off the square root \sqrt{N} of the total number of cameras, and calculates the optimal column number C_{N} by raising the square root \sqrt{N} of the total number of cameras. This will be described below with reference to an example of FIG. 5.

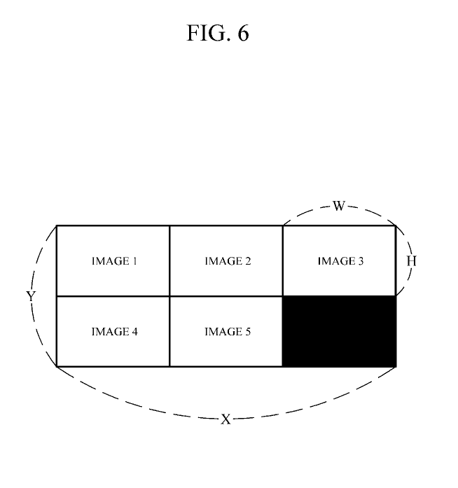

The second calculator 1222 calculates an optimal size of each of the captured images within the tile image. The optimal size includes an optimal lateral length W and an optimal vertical length H. The optimal size of the captured image is a criterion by which the size of the original captured image is adjusted to match an optimal size in a client terminal. The second calculator 1222 according to one embodiment calculates the optimal size of each captured image using optimal matrix values R_{N} and C_{N} calculated by the first calculator 1221, the lateral length w and vertical length h of the original image of a corresponding camera, maximum sizes X and Y of an image that may be displayed on a display. For example, the second calculator 1222 calculates the reference lateral length W of the captured image by multiplying (w×min(Xᵣₐₜᵢₒ, Yᵣₐₜᵢₒ, 1)) the lateral length w of the original image of a corresponding camera and a minimum value min(Xᵣₐₜᵢₒ, Yᵣₐₜᵢₒ, 1) among a lateral length ratio Xᵣₐₜᵢₒ and vertical length ratio Yᵣₐₜᵢₒ of an image, which are maximum sizes acceptable in a display, and 1. Furthermore, the second calculator 1222 calculates the reference vertical length H of the captured image by multiplying (h×(min Xᵣₐₜᵢₒ, Yᵣₐₜᵢₒ, 1)) the vertical length h of the original image of the camera and the minimum value min(Xᵣₐₜᵢₒ, Yᵣₐₜᵢₒ, 1) among the lateral length ratio Xᵣₐₜᵢₒ and vertical length ratio Yᵣₐₜᵢₒ of the image, which are maximum sizes acceptable in the display, and 1. In this case, the lateral length ratio Xᵣₐₜᵢₒ of the image which is a maximum size acceptable in the display is a value X/(C_{N}×w) obtained by dividing the maximum lateral length X of the image that may be displayed on the display by the product of the optimal column number C_{N} of the tile image and the lateral length w of the original image of the camera. The vertical length ratio Yᵣₐₜᵢₒ of the image, which is a maximum size acceptable in the display, is a value Y/(R_{N}×h) obtained by dividing the maximum vertical length Y of the image that may be displayed on the display by the product of the optimal row number R_{N} of the tile image and the vertical length h of the original image of the camera. This will be described below with reference to an example of FIG. 6.

The second calculator 1222 according to one embodiment calculates an optimal size so that a specific restriction condition is satisfied when calculating the optimal size of the captured image. The restriction condition includes, for example, a first condition in which the size of the tile image should not exceed the maximum size of an image that may be displayed on a display, a second condition in which the size of each of the captured images forming the tile image should be equal to or smaller than the size of the original image captured by the camera, and a third condition in which the aspect ratio of each of the captured images forming the tile image should be identical to that of the original image captured by the camera. The second calculator 1222 may calculate the optimal lateral length W and the optimal vertical length H of each captured image that satisfy all of the first condition to the third condition.

The image construction unit 1224 constructs the tile image by combining received captured images after each captured image is adjusted to match the optimal size thereof. In this case, the image construction unit 1224 combines the captured images using image construction information calculated by the first calculator 1221 and the second calculator 1222.

The input unit 123 provides an interface through which input information is received from a user. The input unit 123 may include a control panel, a mouse, or a keyboard. The output unit 124 displays a tile image constructed by the processor 122 on a screen for a user. The output unit 124 may be implemented using a display or software for playing back an image on a display. The storage unit 125 stores the operating process of the image processing apparatus 12 according to one embodiment of the present invention. The storage unit 125 may be implemented using one or more of a common hard disk, a RAM, and a ROM.

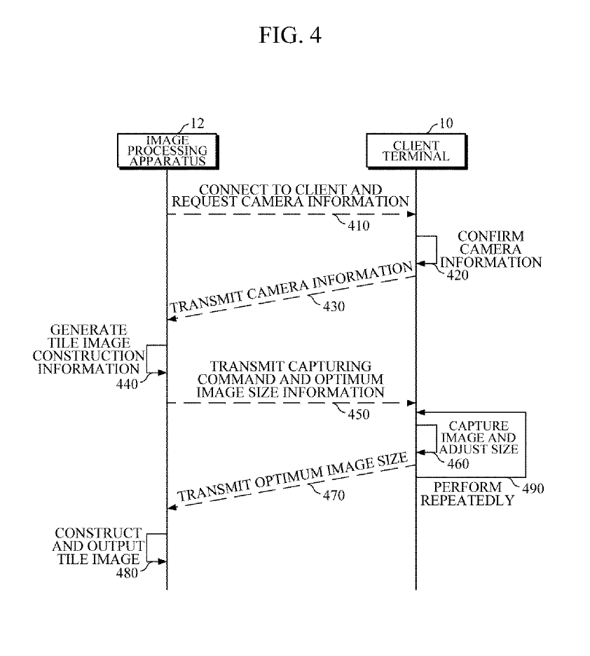

FIG. 4 is a flowchart showing a workflow between the image processing apparatus and a client terminal according to one embodiment of the present invention.

Referring to FIG. 4, the image processing apparatus 12 that attempts to construct and output a tile image is connected to each client terminal 10, to which a camera has been connected, through a network, and then requests camera information necessary for the tile image construction to the connected client terminal 10 (410). The camera information includes the number and resolution information of cameras connected to the client terminal 10. The client terminal 10 that has received the request from the image processing apparatus 12 confirms the camera information (420) and transmits the confirmed camera information to the image processing apparatus 12 (430).

The image processing apparatus 12 generates tile image construction information using the camera information received from the client terminal 10 and display information of the image processing apparatus 12 (440). Basic information necessary to generate the tile image construction information includes the total number of distributed cameras, the lateral length and vertical length of camera resolution, and a maximum lateral length and maximum vertical length of an image that may be displayed on a display. The image processing apparatus 12 generates image construction information for configuring an optimal tile image using the collected basic information. In this case, the image construction information includes an optimal row number and an optimal column number of the tile image and an optimal lateral length and an optimal vertical length of each captured image.

Next, the image processing apparatus 12 transmits optimal size information of a captured image, included in the tile image construction information, to the client terminal 10 along with a capturing command (450). The client terminal 10 that has received the capturing command from the image processing apparatus 12 starts capturing, adjusts the size of each frame image obtained by the camera based on the optimal size of the captured image received from the image processing apparatus 12 (460), and transmits an optimal size image to the image processing apparatus 12 (470). The image processing apparatus 12 receives the optimal size image from each client terminal 10, constructs the tile image by combining the received optimal size images, and outputs the tile image (480). Operation 460 and operation 470 are repeated until capturing by each client terminal 10 is stopped (490). Accordingly, the tile image of the captured images can be constructed and displayed in real time, and the tile image can be automatically constructed.

FIG. 5 is a reference diagram showing a tile image for illustrating a process of calculating an optimal matrix of a tile image according to one embodiment of the present invention.

In FIG. 5, an optimal state of the tile image is defined when the tile image has a square matrix construction. Accordingly, when a total number of distributed cameras is N, an optimal matrix for constructing the tile image is defined as follows. An optimal row and column according to an increase of the number of cameras N are expressed into sequences R_{N} and C_{N} as follows.

R_{N}=1, 1, 2, 2, 2, 2, 3, 3, 3, 3, 3, 3, 4, . . . (N≥1)

C_{N}=1, 2, 2, 2, 3, 3, 3, 3, 3, 4, 4, 4, 4, . . . (N≥1)

In order to derive an equation from the two sequences, relations between the number of cameras N, a square root \sqrt{N} thereof, and the two sequences R_{N} and C_{N} are expressed into the following tables.

The optimal row and the optimal column according to the number of cameras

| N | 1 | 2 | 3 | 4 | 5 | 6 | 7 | 8 | 9 | 10 |
|---|---|---|---|---|---|---|---|---|---|---|
| \sqrt{N} | 1.00 | 1.41 | 1.73 | 2.00 | 2.24 | 2.45 | 2.65 | 2.83 | 3.00 | 3.16 |
| R_{N} | 1 | 1 | 2 | 2 | 2 | 2 | 3 | 3 | 3 | 3 |
| C_{N} | 1 | 2 | 2 | 2 | 3 | 3 | 3 | 3 | 3 | 4 |
| N | 11 | 12 | 13 | 14 | 15 | 16 | 17 | 18 | 19 | 20 |
| \sqrt{N} | 3.32 | 3.46 | 3.61 | 3.74 | 3.87 | 4.00 | 4.12 | 4.24 | 4.36 | 4.47 |
| R_{N} | 3 | 3 | 4 | 4 | 4 | 4 | 4 | 4 | 4 | 4 |
| C_{N} | 4 | 4 | 4 | 4 | 4 | 4 | 5 | 5 | 5 | 5 |
| N | 21 | 22 | 23 | 24 | 25 | 26 | 27 | 28 | 29 | . . . |
| \sqrt{N} | 4.58 | 4.69 | 4.80 | 4.90 | 5.00 | 5.10 | 5.20 | 5.29 | 5.39 | . . . |
| R_{N} | 5 | 5 | 5 | 5 | 5 | 5 | 5 | 5 | 5 | . . . |
| C_{N} | 5 | 5 | 5 | 5 | 5 | 6 | 6 | 6 | 6 | . . . |

From the above tables, the calculation equations of the optimal row R_{N} and the optimal column C_{N} when the total number of cameras is N may be defined as follows.

R_{N}=Round(\sqrt{N})

C_{N}=Ceil(\sqrt{N})

FIG. 6 is a reference diagram showing a tile image for illustrating a process of calculating an optimal size of a captured image according to one embodiment of the present invention.

In order to calculate an optimal size of a captured image, a total number of cameras N, an optimal row number R_{N} of a tile image, and an optimal column number C_{N} of the tile image are necessary. The lateral length w and vertical length h of the original captured image corresponding to camera resolution are additionally necessary.

In one embodiment of the present invention, the tile image and the size of each of captured images forming the tile image are defined to be optimal when closer to a maximum size of an image that may be displayed on the display of the image processing apparatus. In this case, as shown in FIG. 6, it is assumed that a maximum lateral length and a maximum vertical length of an image that may be displayed on the display are X and Y, respectively. In this case, it is assumed that the lateral length and the vertical length of each of the captured images forming the tile image having an optimal size are W and H, respectively.

When the size of the tile image is calculated, the following three conditions need to be satisfied.

(C1) The size of the tile image should not exceed the maximum size of the image that may be displayed on the display.

(C2) The size of each of the captured images forming the tile image should be smaller than or equal to the size of the original image captured by a corresponding camera.

(C3) An aspect ratio of each of the captured images forming the tile image should be the same as that of the original image captured by the camera.

The first condition C1 is a physical restriction attributable to hardware. The second condition C2 is for system resource operation efficiency. Although an image is simply magnified, image quality of the original image is not improved. As a result, only the size of image data is unnecessarily increased, thereby increasing a network and memory share. Furthermore, one embodiment of the present invention has an object of multi-playback for simultaneously checking images captured by any camera. Accordingly, a maximum image size upon playback should not exceed the size of the original image. Furthermore, the last condition C3 is a condition for preventing the distortion of the original image by maintaining an aspect ratio when the image size is adjusted.

Optimal matrix values R_{N} and C_{N} forming the tile image, the original image sizes w and h of a camera, and the maximum sizes X and Y of an image that may be displayed on the display of the image processing apparatus are known. Accordingly, in the case where the tile image is constructed using the captured original images of the cameras without adjusting the image sizes, the size is as follows.

In the case where the lateral length of the tile image formed of the original images is C_{N}×w, the vertical length of the tile image formed of the original images is R_{N}×h, and the ratio of the lateral length of the tile image formed of the original images is 1, the lateral length ratio Xᵣₐₜᵢₒ of an image, which is a maximum size acceptable in the display, may be calculated as follows.

$$1 \text{:} {X}_{ratio} = {C}_{N} \times w \text{:} X \\ X = {X}_{ratio} ( {C}_{N} \times w )$$

$${X}_{ratio} = \frac{X}{{C}_{N} \times w}$$

Likewise, with respect to the vertical length ratio 1 of the tile image formed of the original images, the vertical length ratio Yᵣₐₜᵢₒ of the image, which is a maximum size acceptable in the display , is Yᵣₐₜᵢₒ=Y/(R_{N}×h).

The size of each of the captured images forming the optimal tile image may be obtained by multiplying the obtained Xᵣₐₜᵢₒ and Yᵣₐₜᵢₒ and the lateral length w and the vertical length h of the original image of a corresponding camera. In this case, the size of the tile image should not exceed the image size that may be displayed on the display, each captured image forming the tile image should not be greater than the original image of a corresponding camera, and the ratio of the original image should be maintained in accordance with the conditions C1 to C3. Accordingly, an equation for calculating the optimal lateral length W and the optimal vertical length H of each of the captured images forming the tile image may be defined as follows.

W=w×min(Xᵣₐₜᵢₒ, Yᵣₐₜᵢₒ, 1)

H=h×min(Xᵣₐₜᵢₒ, Yᵣₐₜᵢₒ, 1)

That is, the optimal lateral length W of each captured image has been obtained by multiplying a minimum value min(Xᵣₐₜᵢₒ, Yᵣₐₜᵢₒ, 1) among Xᵣₐₜᵢₒ, Yᵣₐₜᵢₒ, and 1 and the lateral length w of the original image of the camera. The optimal vertical length H of each captured image may been obtained by multiplying a minimum value min(Xᵣₐₜᵢₒ, Yᵣₐₜᵢₒ, 1) among Xᵣₐₜᵢₒ,and 1 and the vertical length h of the original image of the Yᵣₐₜᵢₒ, camera.

In accordance with one embodiment, there are advantages in that the redundant execution of image size adjustment that may occur when a tile image is generated in a distributed system can be prevented, a task process can be reduced, and a work speed through the distributed processing design can be improved. Furthermore, unnecessary resource consumption can be reduced and a cost reduction attributable to system maintenance can be expected by providing parts for automatically calculating and applying an optimal image size necessary to construct the tile image based on a display without a change in an algorithm or software.

The present invention has been described so far based on the embodiments. A person having ordinary skill in the art to which the present invention pertains will understand that the present invention may be implemented in a modified form without departing from the intrinsic characteristics of the present invention. Accordingly, the disclosed embodiments should be considered from a descriptive viewpoint not a limitative viewpoint. The range of the present invention appears in the claims not the above-described description, and all of differences within an equivalent range thereof should be construed as being included in the present invention.

What is claimed is:

1. An image processing apparatus, comprising:
a receiver configured to receive a captured image from each of client terminals connected to at least one camera, wherein the captured image has a size adjusted to match a reference size of the captured image with respect to an original captured image;
a processor configured to generate image construction information for constructing a tile image having an image size which is a maximum size acceptable in a display and to construct the tile image by combining the captured images received from the client terminals;
a transmitter configured to transmit reference size information of the captured image included in the image construction information to each of the client terminals; and
an output unit configured to display the constructed tile image on the display.

2. The image processing apparatus of claim 1, wherein the processor comprises:
a first calculator configured to calculate matrix values comprising a row number and a column number of the tile image;
a second calculator configured to calculate the reference size of each captured image comprising a reference lateral length and a reference vertical length of the captured image within the tile image; and
an image construction unit configured to construct the tile image by combining the captured images, each having a size adjusted to match the reference size of the captured image, based on the image construction information calculated by the first calculator and the second calculator.

3. The image processing apparatus of claim 2, wherein the first calculator calculates the matrix values (R_{N} and C_{N}) using a total number of distributed cameras through each of the client terminals.

4. The image processing apparatus of claim 3, wherein the first calculator calculates a row number (R_{N}) by rounding off a square root of the total number of cameras and calculates a column number (C_{N}) by raising the square root of the total number of cameras.

5. The image processing apparatus of claim 2, wherein the second calculator calculates the reference size of the captured image using the matrix values (R_{N} and C_{N}) calculated by the first calculator, a lateral length (w) and a vertical length (h) of an original image of a camera, and image sizes (X and Y) which are maximum sizes acceptable in the display.

6. The image processing apparatus of claim 5, wherein:
the second calculator calculates a reference lateral length (W) of the captured image by multiplying a minimum value (min(Xᵣₐₜᵢₒ, Yᵣₐₜᵢₒ, 1)) among a lateral length ratio (Xᵣₐₜᵢₒ) and a vertical length ratio (Yᵣₐₜᵢₒ) of the image, which are maximum sizes acceptable in the display, and 1 and the lateral length (w) of the original image of the camera, and calculates a reference vertical length (H) of the captured image by multiplying the minimum value (min(Xᵣₐₜᵢₒ, Yᵣₐₜᵢₒ, 1)) among the lateral length ratio (Xᵣₐₜᵢₒ) and the vertical length ratio (Yᵣₐₜᵢₒ) of the image, which are maximum sizes acceptable in the display, and 1 and the vertical length (h) of the original image of the camera;
the lateral length ratio (Xᵣₐₜᵢₒ) of the image, which is a maximum size acceptable in the display, is a value obtained by dividing the lateral length (X) of the image, which is a maximum size acceptable in the display, by a product (C_{N}×w) of a column number (C_{N}) of the tile image and the lateral length (w) of the original image of the camera; and
the vertical length ratio (Yᵣₐₜᵢₒ) of the image, which is a maximum size acceptable in the display , is a value obtained by dividing the vertical length (Y) of the image, which is a maximum size acceptable in the display, by a product (R_{N}×h) of a row number (R_{N}) of the tile image and the vertical length (h) of the original image of the camera.

7. The image processing apparatus of claim 6, wherein the second calculator confirms whether a size of the tile image corresponds to a first condition in which the size of the tile image does not exceed a maximum size of the image, which is acceptable in the display, a second condition in which the size of each of the captured images forming the tile image needs to be smaller than or equal to a size of the original image captured by the camera, and a third condition in which an aspect ratio of each of the captured images forming the tile image needs to be identical to that of the original image captured by the camera, and calculates the reference lateral length (W) and the reference vertical length (H) of a captured image satisfying all of the first condition to the third condition.

8. The image processing apparatus of claim 1, wherein:
the transmitter transmits the reference size information of the captured image to each of the client terminals along with a capturing command;
the receiver receives each of the captured images having a size adjusted to match an image reference size from each client terminal while capturing is performed in each of the client terminals;
the processor generates the tile image by combining the received captured images without a change in size of the received captured images; and
the output unit displays the generated tile image in real time.

9. A method of constructing a tile image using an image processing apparatus, the method comprising:
generating image construction information for constructing a tile image using camera information collected from each of client terminals and display information for displaying the tile image;
transmitting reference size information of a captured image within the image construction information to each of the client terminals along with a capturing command;
receiving the captured image having a size adjusted to match a reference size of the captured image with respect to an original captured image from each of the client terminals; and
constructing the tile image by combining the received images.

10. The method of claim 9, wherein the generating of the image construction information comprises:
calculating a matrix value comprising a row number (R_{N}) and a column number (C_{N}) of the tile image; and
calculating the reference size of each of the captured images comprising a reference lateral length (W) and a reference vertical length (H) of the captured image within the tile image,
wherein the constructing of the tile image comprises constructing the tile image by combining the captured images, each having a size adjusted to match the reference size of the captured image, based on the image construction information calculated by a first calculator and a second calculator.

11. The method of claim 10, wherein the calculating of the reference size of the captured image comprises:
calculating the reference lateral length (W) of the captured image by multiplying a minimum value (min(Xᵣₐₜᵢₒ, Yᵣₐₜᵢₒ, 1)) of a lateral length ratio (Xᵣₐₜᵢₒ) and a vertical length ratio (Yᵣₐₜᵢₒ) of an image, which are maximum sizes acceptable in a display, and 1 and a lateral length (w) of the original image of the camera; and
calculating a reference vertical length (H) of the captured image by multiplying the minimum value (min(Xᵣₐₜᵢₒ, Yᵣₐₜᵢₒ, 1)) of the lateral length ratio (Xᵣₐₜᵢₒ) and the vertical length ratio (Yᵣₐₜᵢₒ) of the image, which are maximum sizes acceptable in the display, and 1 and the vertical length (h) of the original image of the camera,
wherein the lateral length ratio (Xᵣₐₜᵢₒ) of the image, which is a maximum size acceptable in the display, is a value obtained by dividing the lateral length (X) of the image, which is a maximum size acceptable in the display, by a product (C_{N}×w) of a column number (C_{N}) of the tile image and the lateral length (w) of the original image of the camera, and
the vertical length ratio (Yᵣₐₜᵢₒ) of the image, which is a maximum size acceptable in the display, is a value obtained by dividing the vertical length (Y) of the image, which is a maximum size acceptable in the display, by a product (R_{N}×h) of the row number (R_{N}) of the tile image and the vertical length (h) of the original image of the camera.
